(19) United States
(12) Patent Application Publication
(10) Pub. No.: US 2007/0003328 A1
(43) Pub. Date: Jan. 4, 2007

(54) Electrophotographic image forming apparatus and method of developing an image

(75) Inventors: Naonori Kurogawa, Suwon-si (KR); Masahiko Itaya, Suwon-si (KR); Kyu-cheol Shin, Seoul (KR); Tsutomu Teraoka, Seongnam-si (KR); Tsutomu Sasaki, Suwon-si (KR); Myung-kook Ahn, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/439,255

(22) Filed: May 24, 2006

(30) Foreign Application Priority Data
Jul. 4, 2005 (KR) 10-2005-0059717

(51) Int. Cl. G03G 15/08

(52) U.S. Cl. 399/281; 399/285

(57) ABSTRACT

A hybrid type developing apparatus of an electrophotographic image forming apparatus includes: an image receptor on which an electrostatic latent image is formed; a magnetic roller for forming a magnetic brush of non-magnetic toner and magnetic carrier by using magnetic force; a donor roller which faces the image receptor and has a circumference for supporting a toner layer formed by receiving toner from the magnetic roller; a bias voltage applying device for applying a development bias voltage to the donor roller to develop toner of the toner layer to the electrostatic latent image; an electrode positioned at an upstream side at a point closest and most adjacent position between the donor roller and the image receptor and at a downstream side at a point closest and most adjacent position between the donor roller and the magnetic roller and an applied bias voltage of weakening adhesive force of the toner layer to the donor roller and cohesive force of toner to each other.

### CROSS-REFERENCE TO RELATED PATENT APPLICATION

This application claims the benefit of Korean Patent Application No. 10-2005-0059717, filed on Jul. 4, 2005, in the Korean Intellectual Property Office, the disclosure of which is hereby incorporated by reference in its entirety.

### BACKGROUND OF THE INVENTION

1. Field of the Invention

The present invention relates to an image forming apparatus and to a method of developing an electrophotographic image. More particularly, the invention relates to an electrophotographic image forming apparatus using a magnetic carrier and a nonmagnetic toner and to a method of developing an image using the apparatus.

2. Description of the Related Art

Developing methods for an electrophotographic image forming apparatus such as a copying machine, a printer, a facsimile, and a multi-function apparatus, can be classified into three types: dual component developing methods wherein a toner and a carrier are used, mono component developing methods wherein an insulating toner or a conductive toner is used, and hybrid developing methods where a nonmagnetic toner is charged by rubbing with a magnetic carrier, only charged toner is attached on to a development roller, and the toner forms an electrostatic latent image and developing the electrostatic latent image.

The dual component developing method has the advantages of excellent toner charging, long durability of the toner, realization of uniform beta images, as well as others. On the other hand, the dual component developing method has the disadvantages of requiring a bigger and more complicated image forming apparatus, and exhibiting scattering of the toner, carrier attachment to a latent image, image-quality deterioration due to durability deterioration of the carrier, and others.

The mono component developing method has the advantages of providing a compact developing apparatus and excellent dot reproduction, but has the disadvantages of lower durability due to deterioration of a development roller and charging roller, expensive supplies due to the need of replacing the developing apparatus itself when toner is exhausted, occurrence of selection development, and others. The selection development means that only toner having a desired weight and charge is moved to form the latent images from the developing roller. If the selection development is continued, because toner having smaller weight and charge than required cannot be used for image development, the ratio of usable toner may be reduced.

The hybrid developing method has the advantages of both the mono component developing method and the dual component developing method, and the advantage of excellent dot reproduction, long durability, and high speed image formation as well.

### SUMMARY OF THE INVENTION

The present invention provides an image forming apparatus and a method of developing an image that is capable of obtaining a higher development ratio of the toner and a stable image quality for a long period of time.

According to an aspect of the present invention, an electrophotographic image forming apparatus includes an image receptor on which an electrostatic latent image is formed; a magnetic roller for forming a magnetic brush of a non-magnetic toner and a magnetic carrier by using a magnetic force; a donor roller which faces the image receptor and on a circumference of which a toner layer is formed by receiving the non-magnetic toner from the magnetic roller; a bias voltage applying means for applying a developing bias voltage to the donor roller so as to develop toner or the toner layer into the electrostatic latent image; and an electrode positioned on an upstream side of most adjacent position between the donor roller and the image receptor and a downstream side of most adjacent position between the donor roller and the magnetic roller and to which bias voltage for reducing an adhesive force of the toner layer to the donor roller and cohesive force of toner to each other is applied.

According to an aspect of the present invention, a plurality of electrodes may be disposed.

According to another aspect of the present invention, a gap between the electrode and the donor roller is larger than a thickness of the toner layer on the donor roller.

According to a further aspect of the present invention, at least one of the development bias voltage and the bias voltages applied to the electrode is formed by an AC voltage and a DC voltage superposed upon each other.

According to another aspect of the present invention, the development bias voltage and the bias voltage applied to the electrode have the same average voltage.

According to another aspect of the present invention, a method for developing an image includes forming a toner layer on a circumference of a donor roller by supplying a toner from a magnetic roller, which forms a magnetic brush of a non-magnetic toner and a magnetic carrier using a magnetic force, to the donor roller; applying a developing bias voltage between the donor roller and an image receptor on which an electrostatic latent image is formed so as to develop the electrostatic latent image, the developing method comprising: applying a bias voltage to an electrode positioned on an upstream side of the most adjacent position between the donor roller and the image receptor and a downstream side of the most adjacent position between the donor roller and the magnetic roller so as to weaken adhesive force of the toner layer to the donor roller and cohesive force of the toner to each other.

These and other features will become apparent from the detailed description of the invention in conjunction with the annexed drawings which disclose various embodiments of the invention.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic diagram of an electrophotographic image forming apparatus according to an embodiment of the present invention;

FIG. 2 is a diagram depicting a magnetic brush;

FIG. 3 is a diagram depicting an installation position of a toner removing means; and

FIG. 4 is a schematic diagram of an electrophotographic image forming apparatus according to another embodiment of the present invention.

### DETAILED DESCRIPTION OF THE INVENTION

Hereinafter, exemplary embodiments of the present invention will be described in detail with reference to the accompanying drawings. The exemplary embodiments of the present invention are not limited to the attached drawings but may be modified in form without departing from the scope of the present invention.

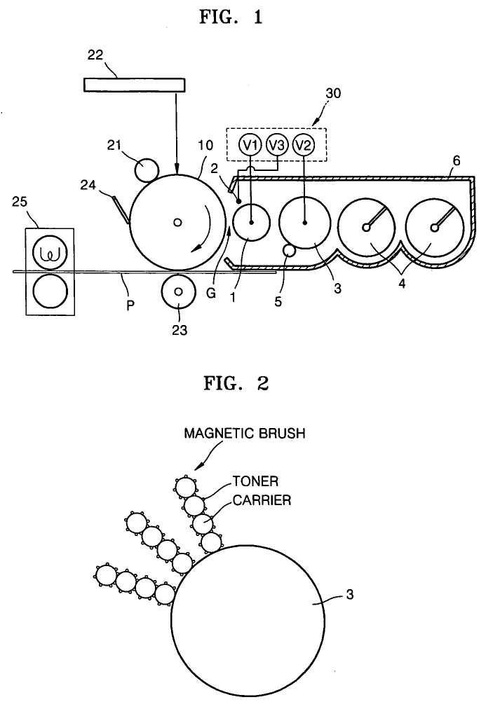

FIG. 1 is a schematic diagram illustrating an electrophotographic image forming apparatus according to an embodiment of the present invention. Referring to FIG. 1, the developing apparatus is a hybrid type developing apparatus including an image receptor 10, a donor roller 1, a magnetic roller 3, and an agitator 4. In the present embodiment, an organic photo conductor is employed as the image receptor 10. Alternatively, an amorphous silicon photo conductor may be employed as the image receptor 10. A charging device 21 and an exposure device 22 are provided to form an electrostatic latent image on the image receptor 10. A corona charge device or a charging roller may be employed as the charging device 21. A laser scanning unit (LSU) irradiating a laser beam may be employed as the exposure device 22. In another embodiment, an electrostatic drum (not shown) may be employed as the image receptor 10. In such case, an electrostatic recording head (not shown) may be employed instead of the exposure device 22 to form an electrostatic latent image.

Non-magnetic toner and a magnetic carrier is held in a developing device 6. The carrier is not limited. In one embodiment, a magnetic powder type is used. The agitator 4 agitates the carrier and the non-magnetic toner to frictionally charge the toner with electricity. The non-magnetic toner may be positively or negatively charged. The carrier is attached to the circumference of the magnetic roller 3 by a magnetic force of the magnetic roller 3, and the toner is attached to the carrier by an electrostatic force. As a result, as shown in FIG. 2, a magnetic brush comprised of the carrier and the toner is formed on the circumference of the magnetic roller 3. A trimmer 5 as shown in FIG. 1 forms the magnetic brush to a predetermined thickness. It is desirable that the gap between the trimmer 5 and the magnetic roller 3 be between 0.3 and 1.5 mm.

The donor roller 1 is positioned between the image receptor 10 and the magnetic roller 3. A gap (a development gap G) between the donor roller 1 and the image receptor 10 in most adjacent position is between 150 and 400 μm, and preferably between 200 and 300 μm. The gap G is defined as the closest point between the image receptor 10 and the donor roller 3. The development gap G smaller than 150 μm produces background fog. On the other hand, if the development gap G is larger than 400 μm, a sufficient image density cannot be obtained because it is hard to move the toner to the image receptor 10, which causes selection development. A gap G1 defined by the closest points between the magnetic roller 3 and the donor roller 1 in the most adjacent position is between about 0.2 and about 1.0 mm, and preferably between 0.3 and 0.4 mm. The donor roller 1 has a cylindrical shape and is made of conductive aluminum or stainless steel having a volume resistivity of 10⁶Ω·cm³ or less. Also the donor roller 1 can have a cylindrical shape, with the circumference coated with a conductive resin of the same volume resistivity.

A bias voltage applying device 30 applies a development bias voltage V1 and a supply bias voltage V2 to the donor roller 1 and the magnetic roller 3, respectively. As the supply bias voltage V2 for providing an electric field between the magnetic roller 3 and the donor roller 1 to move the toner from the magnetic roller 3 to the donor roller 1, a DC voltage or a DC voltage superposed on an AC voltage may be employed. A toner layer is formed on the circumference of the donor roller 1 by the supply bias voltage V2. The development bias voltage V1 has to separate the toner from the toner layer formed on the circumference of the donor roller 1 and then move the toner to the image receptor 10 across the development gap G. A DC voltage or a DC voltage superposed on an AC voltage may be employed as the development bias voltage V1.

Accordingly, the charging device 21 charges the surface of the image receptor 10, which is a photo conductor, to a uniform electric potential. The exposure device 22 allows light corresponding to the image information to reach the image receptor 10. As a result, an electrostatic latent image comprised of an imaging part and a non-imaging part having different electric potentials from each other, is formed on the surface of the image receptor 10. The toner is separated from the magnetic brush by the supply bias voltage V2 applied to the magnetic roller 3 and is then supplied to the donor roller 1. A uniform toner layer is formed on the circumference of the donor roller 1. When the toner layer formed on the donor roller 1 passes through the development gap G, and faces the imaging part of the electrostatic latent image, the toner is separated from the toner layer of the donor roller 1 and then attached to the imaging part to develop the electrostatic latent image into a visible toner image. The toner image is transferred onto a recording medium P by an electric field provided by a transfer device 23. A fixing unit 25 fixes the toner image on the recording medium P by using heat and pressure. A cleaning blade 24 removes the toner remaining on the surface of the image receptor 10.

The toner layer remains on the surface of the donor roller 1 due to electrostatic adhesive force between the donor roller 1 and the toner layer and the cohesive force among the toner particles. An image force between the toner and the donor roller 1 and the Van der Waals' force act as the adhesive force. The Van der Waals' force among toner particles acts as the cohesive force. The adhesive force and cohesive force lower the development ratio of toner from the donor roller 1 to the image receptor 10 to reduce the image density.

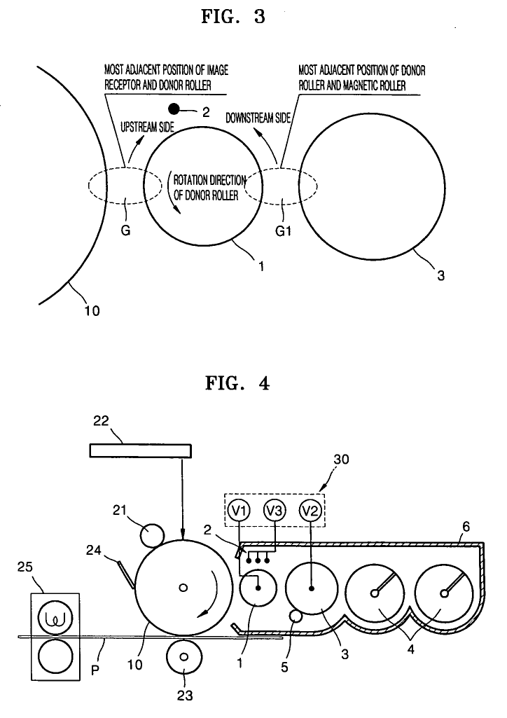

According to a method of developing an image of the present invention, the adhesive force between the donor roller 1 and the toner layer and cohesive force among toner particles are reduced before the toner layer on the donor roller 1 reaches the development gap G. Thus, the image forming apparatus of the present invention includes an electrode 2 as shown in FIG. 1. A bias voltage V3 for reducing the adhesive force and the cohesive force is applied to the electrode 2. The bias voltage V3 may be provided by the bias voltage applying device 30. The electrode 2 is positioned in not only an upstream side of the closest point between the donor roller 1 and the image receptor 10 but also a downstream side of the closest point between the magnetic roller 3 and the donor roller 1. The downstream side of the most adjacent position or the closest point between the magnetic roller 3 and the donor roller 1 and the upstream side of the most adjacent position or closest point between the donor roller 1 and the image receptor 10 are shown in FIG. 3. In the closest and most adjacent position between the magnetic roller 3 and the donor roller 1, the toner is supplied from the magnetic roller 3 to the donor roller 1 by the supply bias voltage V2 which is applied to the magnetic roller 3. The stronger the supply bias voltage V2 applied to the magnetic roller 3, the stronger the adhesive force of the toner layer to the donor roller 1 and the stronger cohesive force among the non-magnetic toner particles. In the closest and most adjacent position between the donor roller 1 and the image receptor 10, the toner is developed onto the electrostatic latent image of the image receptor 10 due to the development bias voltage V1 applied to the donor roller 1.

Any type of electrode capable of generating an electric field upon the toner layer on the donor roller 1, such as a rubber roller, an aluminum roller, a plate shape electrode, and a wire may be used as the electrode 2. The electrode 2 may be in contact with or not in contact with the toner layer on the donor roller 1. In case of using a rubber roller as the electrode 2, the electrode can be in contact with the toner layer. When an aluminum roller, a plate shape electrode, or a wire is used, it is desirable that the electrode not be in contact with the toner layer. The electrode 2 does not contact the toner layer where a gap between the electrode 2 and the donor roller 1 is greater than the thickness of the toner layer on the donor roller 1. In the present embodiment, a simple and inexpensive wire is used as the electrode 2.

In an aspect of the present invention, the toner is negatively charged. Electric potentials of the non-imaging part and imaging part of the image receptor 10 are −600V and −50V, respectively, and an electric potential of the supply bias voltage V2 applied to the magnetic roller 3 is −600V. The development bias voltage V1 has a square wave shape with a peak-to-peak value of 1.5 KV, a frequency of 3 KHz, and cycle duty of 50%. An average voltage V1 of −200V is applied to the donor roller 1. Here, the average voltage means a time average voltage of the square wave V1. The imaging part and the non-imaging part of the latent image formed on the image receptor 10 are an area where the toner is attached and a background area where the toner is not attached, respectively.

A negatively charged toner is supplied to the donor roller 1 in the closest point or most adjacent position between the magnetic roller and the donor roller 1 due to voltage potential difference between the magnetic roller 3 and the donor roller 1. The toner layer on the donor roller 1 is maintained on the donor roller 1 by the adhesive force and the cohesive force and is then moved to the closest point or most adjacent position between the image receptor 10 and the donor roller 1. A bias voltage of −100V is applied to the electrode 2. As the absolute value of the bias voltage V3 is smaller than the absolute value of the average voltage of the development bias voltage V1 applied to the donor roller 1, the toner of the toner layer tends to move toward and to be attached to the electrode 2. Thus, the adhesive force of the toner layer to the donor roller 1 is reduced. An electric field formed by the square wave type development bias voltage V1 applied to the donor roller 1 and the bias voltage V3 applied to the electrode 2, causes toner particles of the toner layer to be repeatedly placed in a secession force from the toner layer and a maintenance force to maintain the toner layer, such that the toner particles vibrate. Thus, the cohesive force among the toner particles and the adhesive force of the toner layer to the donor roller 1 are reduced. According to the embodiment described above, it is desirable that any one of the bias voltage V1 applied to the donor roller 1 and the bias voltage V3 applied to the electrode 2 has a square wave shape where a DC voltage and an AC voltage are superposed on each other.

When the absolute value of the bias voltage V3 is smaller than the absolute value of the average of the development bias voltage V1 applied to the donor roller 1, some amount of toner of the toner layer on the donor roller 1 may be attached to the electrode 2. In order to decrease the amount of the toner attached to the electrode 2, the absolute value of the bias voltage V3 applied to the electrode 2 is equal to the absolute value of the average bias voltage V1 applied to the donor roller 1. Namely, in the embodiment described above, the bias voltage V3 is −200V. Therefore, the amount of the toner attached to the electrode 2 can be decreased.

In addition, as shown in FIG. 4, it is possible to provide a plurality of electrodes 2. As a result, it is possible to reduce further the adhesive force of the toner layer to the donor roller 1 and reduce the cohesive force among the toner particles.

When the toner layer reaches the closest point or most adjacent position between the image receptor 10 and the donor roller 1, the reduced adhesive force and cohesive force enables the toner to be developed into the image part of the image receptor 10 due to the electric potential difference between the image part of the image receptor 10 and the donor roller 1. As the adhesive force and the cohesive force of the toner layer on the donor roller 1 are reduced, more toner is more easily developed into the image part of the image receptor 10. Thus, the development ratio of toner from the donor roller 1 to the image receptor 10 is increased to obtain a high resolution image. Also, stable image quality can be obtained for a long period of time.

In the above mentioned embodiment, a single color image forming apparatus and a developing method therefor are disclosed. In other embodiments, the image forming apparatus and the developing method therefor can also be applied to a single-pass type color image forming apparatus having a tandom construction and a multi-pass type color image forming apparatus where a single image receptor is repeatedly developed and then sequentially transferred to an intermediate transfer.

As described above, according to the electrophotographic image forming apparatus and the developing method therefor according to the present invention, the development ratio of toner is increased by providing an electrode and then applying a bias voltage to the electrode, such that a high density image and stable image quality for a long period can be obtained.

While the present invention has been particularly shown and described with reference to exemplary embodiments thereof, it will be understood by those skilled in the art that various changes in form and details may be made therein without departing from the spirit and scope of the present invention as defined by the appended claims.

What is claimed is:

1. An electrophotographic image forming apparatus comprising:
an image receptor on which an electrostatic latent image is formed;
a magnetic roller for forming a magnetic brush of a non-magnetic toner and magnetic carrier by using a magnetic force;
a donor roller facing the image receptor and having a circumference on which a toner layer is formed by receiving the non-magnetic toner from the magnetic roller;
a bias voltage applying device for applying a development bias voltage to the donor roller to develop the toner of the toner layer into the electrostatic latent image; and
an electrode positioned on an upstream side of a closest point between the donor roller and the image receptor and a downstream side of a closest point between the donor roller and the magnetic roller to which is applied a bias voltage for reducing an adhesive force of the toner layer to the donor roller and a cohesive force of toner to each other.

2. The electrophotographic image forming apparatus according to claim 1, comprising a plurality of the electrodes.

3. The electrophotographic image forming apparatus according to claim 1, wherein a gap between the electrode and the donor roller is larger than a thickness of the toner layer on the donor roller.

4. The electrophotographic image forming apparatus according to claim 3, wherein at least one of the development bias voltage and the bias voltage applied to the electrode is formed of an AC voltage and a DC voltage superposed upon each other.

5. The electrophotographic image forming apparatus according to claim 4, wherein the development bias voltage and the bias voltage applied to the electrode have the same average voltage.

6. The electrophotographic type image forming apparatus according to claim 1, wherein the electrode is a wire electrode.

7. A method for forming an electrophotographic image comprising
forming a toner layer on a circumference of the donor roller by supplying toner from a magnetic roller, the magnetic roller forming a magnetic brush of non-magnetic toner and magnetic carrier using magnetic force to the donor roller;
applying a bias voltage to an electrode positioned on an upstream side of a closest point between the donor roller and an image receptor and a downstream side of a closest point between the donor roller and the magnetic roller so as to reduce an adhesive force of the toner layer to the donor roller and cohesive force of toner particles to each other; and
applying a developing bias voltage between the donor roller and the image receptor on which an electrostatic latent image is formed, to develop the electrostatic latent image.

8. The method according to claim 7, wherein a plurality of the electrodes are positioned on an upstream side of a closest point between the donor roller and an image receptor an a downstream side of a closest point between the donor roller and the magnetic roller.

9. The method according to claim 7, wherein a gap between the electrode and the donor roller is larger than a thickness of the toner layer on the donor roller.

10. The method according to claim 9, wherein at least one of the development bias voltage and a bias voltage applied to the electrode is formed of an AC voltage and a DC voltage superposed upon each other.

11. The method according to claim 10, wherein the development bias voltage and the bias voltage applied to the electrode have the same average voltage.
